(19) United States
(12) Patent Application Publication
(10) Pub. No.: US 2015/0310990 A1
(43) Pub. Date: Oct. 29, 2015

(54) MULTILAYER CERAMIC CAPACITOR

(71) Applicant: Qualcomm Incorporated, San Diego, CA (US)

(72) Inventors: Lalan Jee Mishra, San Diego, CA (US); Shree Krishna Pandey, San Diego, CA (US); Nazanin Darbanian, San Diego, CA (US); John David Eaton, San Diego, CA (US)

(73) Assignee: QUALCOMM INCORPORATED, San Diego, CA (US)

(21) Appl. No.: 14/261,373

(22) Filed: Apr. 24, 2014

(51) Int. Cl. H01G 4/30

(52) U.S. Cl. CPC H01G 4/30

(57) ABSTRACT

Aspects of a method of manufacturing a capacitor are provided. The method includes layering a plurality of dielectric plates. The plurality of dielectric plates includes a first dielectric plate having a first conductive region and a second conductive region on a surface of the first dielectric plate. The method further includes forming an inner electrode through an axis of the layered plurality of dielectric plates. The inner electrode electrically couples to the first conductive region on the surface of the first dielectric plate. The method further includes forming an outer electrode, where the outer electrode electrically couples to the second conductive region on the surface of the first dielectric plate.

### BACKGROUND

1. Field

The present disclosure relates generally to a multilayer ceramic capacitor (MLCC), and more particularly, to a method for manufacturing an (e.g., coaxial) MLCC.

2. Background

The growing number of applications for MLCCs is increasing the demand for MLCCs. An MLCC includes multiple interlaced (e.g., alternately layered) dielectric layers and conductive layers. The interlaced dielectric layers and conductive layers may be formed by ceramic plates having a conductive material disposed thereon to form the conductive layers and the electrodes of the capacitor. The MLCC may include a stack of multiple ceramic plates. The layered configuration may substantially increase the area of the dielectric layer being disposed between the conductive layers within a fixed footprint. Due to the layered configuration, an MLCC may provide high capacitance in a relatively small package. Moreover, MLCCs may be mounted on a circuit board with less complexity than other types of chip-carrier packages. Accordingly, MLCCs are widely used as components of mobile communications equipments, such as cell phones.

### SUMMARY

Aspects of a method of manufacturing a capacitor are provided. The method includes layering a plurality of dielectric plates. The plurality of dielectric plates includes a first dielectric plate having a first conductive region and a second conductive region on a surface of the first dielectric plate. The method further includes forming an inner electrode through an axis of the layered plurality of dielectric plates. The inner electrode electrically couples to the first conductive region on the surface of the first dielectric plate. The method further includes forming an outer electrode. The outer electrode electrically couples to the second conductive region on the surface of the first dielectric plate.

It is understood that other aspects of apparatus and methods will become readily apparent to those skilled in the art from the following detailed description, wherein various aspects of apparatus and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatus and methods will now be presented in the detailed description by way of example, and not by way of limitation, with reference to the accompanying drawings, wherein:

FIG. 1 is an isometric view of an MLCC.

FIG. 2 is a flowchart of an exemplary method for manufacturing an MLCC.

FIG. 3 is an exemplary embodiment of the layers of an MLCC.

FIG. 4 is an illustration of the layering in the exemplary method for manufacturing an MLCC.

FIG. 5 is an illustration of the electrical connection of an inner electrode to the layers of an MLCC.

FIG. 6 is an illustration of the electrical connection of an outer electrode to the layers of an MLCC.

### DETAILED DESCRIPTION

The detailed description set forth below in connection with the appended drawings is intended as a description of various exemplary embodiments of the present invention and is not intended to represent the only embodiments in which the present invention may be practiced. The detailed description includes specific details for the purpose of providing a thorough understanding of the present invention. However, it will be apparent to those skilled in the art that the present invention may be practiced without these specific details. In some instances, well-known structures and components are shown in block diagram form in order to avoid obscuring the concepts of the present invention. Acronyms and other descriptive terminology may be used merely for convenience and clarity and are not intended to limit the scope of the invention.

The word “exemplary” is used herein to mean serving as an example, instance, or illustration. Any embodiment described herein as “exemplary” is not necessarily to be construed as preferred or advantageous over other embodiments. Likewise, the term “embodiment” of an apparatus or method does not require that all embodiments of the invention include the described components, structure, features, functionality, processes, advantages, benefits, or modes of operation.

The terms “connected,” “coupled,” or any variant thereof, mean any connection or coupling, either direct or indirect, between two or more elements, and can encompass the presence of one or more intermediate elements between two elements that are “connected” or “coupled” together. The coupling or connection between the elements can be physical, logical, or a combination thereof. As used herein, two elements can be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element.

As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of the stated features, integers, steps, operations, elements, and/or components, but do not preclude the presence or addition of one or more other features, integers, steps, operations, elements, components, and/or groups thereof

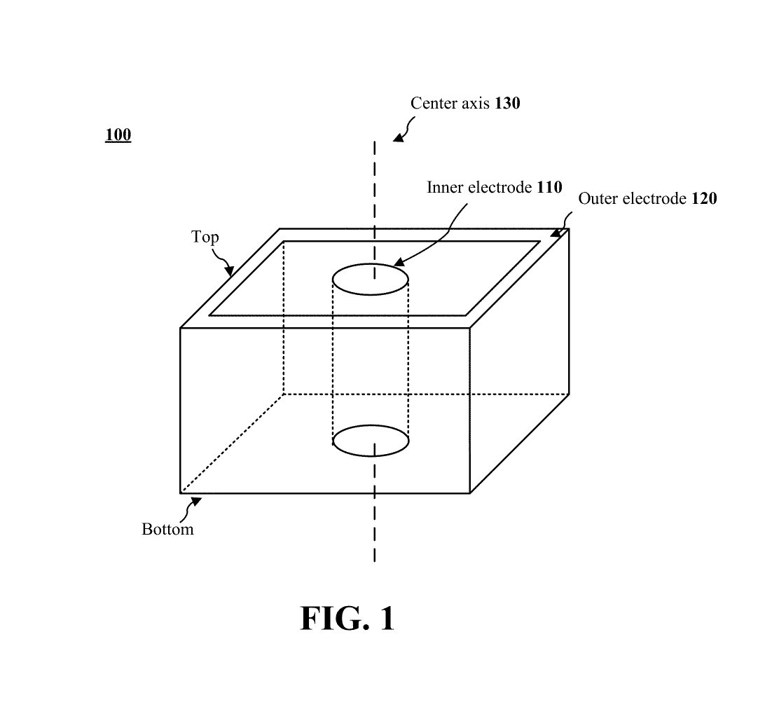

FIG. 1 is an isometric view of an MLCC 100. As shown in FIG. 1, the MLCC 100 includes an inner electrode 110 in an inner portion of the MLCC 100. In one example, the inner electrode 110 is formed along the center axis 130 of the device. The outer electrode 120 forms an outer surface of the MLCC 100. The inner electrode 110 and the outer electrode 120 may be centered on the common center axis 130, and therefore, the inner electrode 110 and the outer electrode 120 may be considered as coaxial.

In one example, the inner electrode 110 serves as the anode, and the outer electrode 120 serves as the cathode of the MLCC 100. In one configuration, the top or bottom of the coaxial MLCC 100 or both may be a mounting surface. In such case, both electrodes on the same surface (top or bottom) are available for mounting, and therefore, the process of mounting the MLCC 100 onto a circuit board may be simplified. As one of ordinary skill in the art would readily recognize, although the MLCC 100 is illustrated as a rectangular device, the MLCC 100 may be configured to have other shapes in other aspects. For example, the MLCC 100 may have a cylindrical shape. Moreover, although the outer electrode 120 is illustrated as covering all four sides of the MLCC 100, it should be understood that the electrode 120 may cover less than four sides of the MLCC 100 in other aspects. For example, the outer electrode 120 may cover only one, two, or three sides of the MLCC 100.

The MLCC 100 may be manufactured by interlacing (or alternately layering) a plurality of dielectric layers and a plurality of conductive layers. In one example, layers include dielectric plates, which may be ceramic plates (e.g., ceramic sheets). The conductive layer may be disposed on the ceramic plate in a predetermined pattern. In an aspect, the conductive layer may be conductive ink. The conductive layers may be electrically connected to function as the electrodes 110 and 120 of the MLCC 100. In one example, the ceramic plates are layered (e.g., disposed on top of each other in a stack configuration). The layering process may further include a laminating process, which involves the application of heat and/or pressure to the stack of layered ceramic plates.

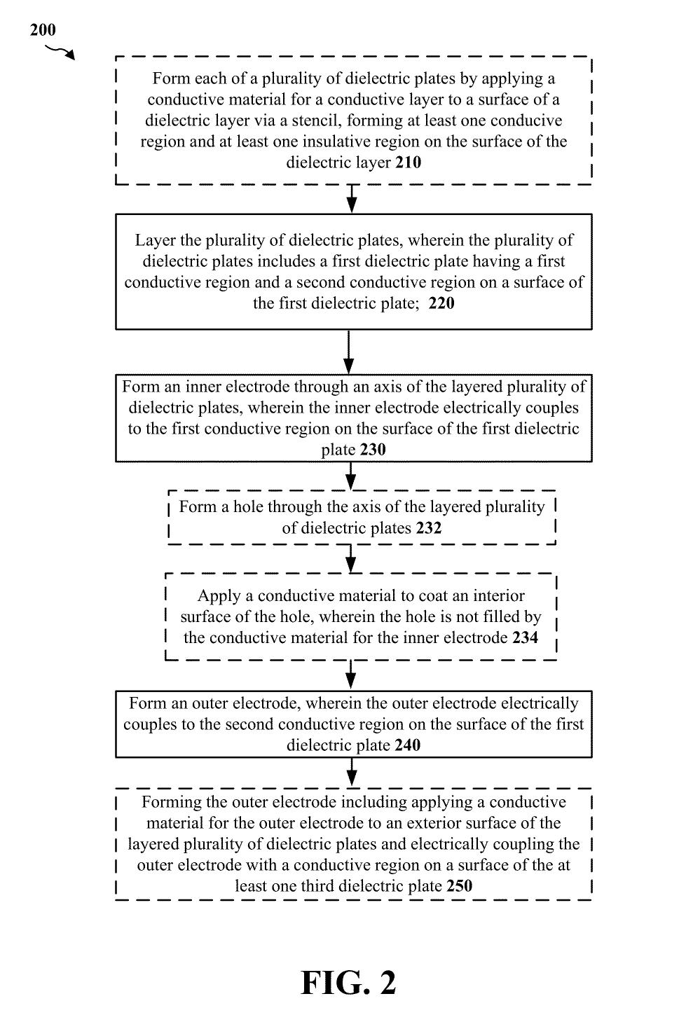

FIG. 2 is a flowchart 200 of an exemplary method for manufacturing the MLCC 100. At step 210, each of a number of dielectric plates are formed by applying a conductive material for a conductive layer to a surface of a dielectric layer (e.g., a ceramic plate) via a stencil, thereby forming at least one conducive region and at least one insulative region on the surface of the dielectric layer. At step 220, the number of dielectric plates is layered. In an aspect, the number of dielectric plates includes a first dielectric plate having a first conductive region and a second conductive region on a surface of the first dielectric plate. In an aspect, the layered dielectric plates may include at least one second dielectric plate and at least one third dielectric plate, where the at least one second dielectric plate and at least one third dielectric plate are alternately layered.

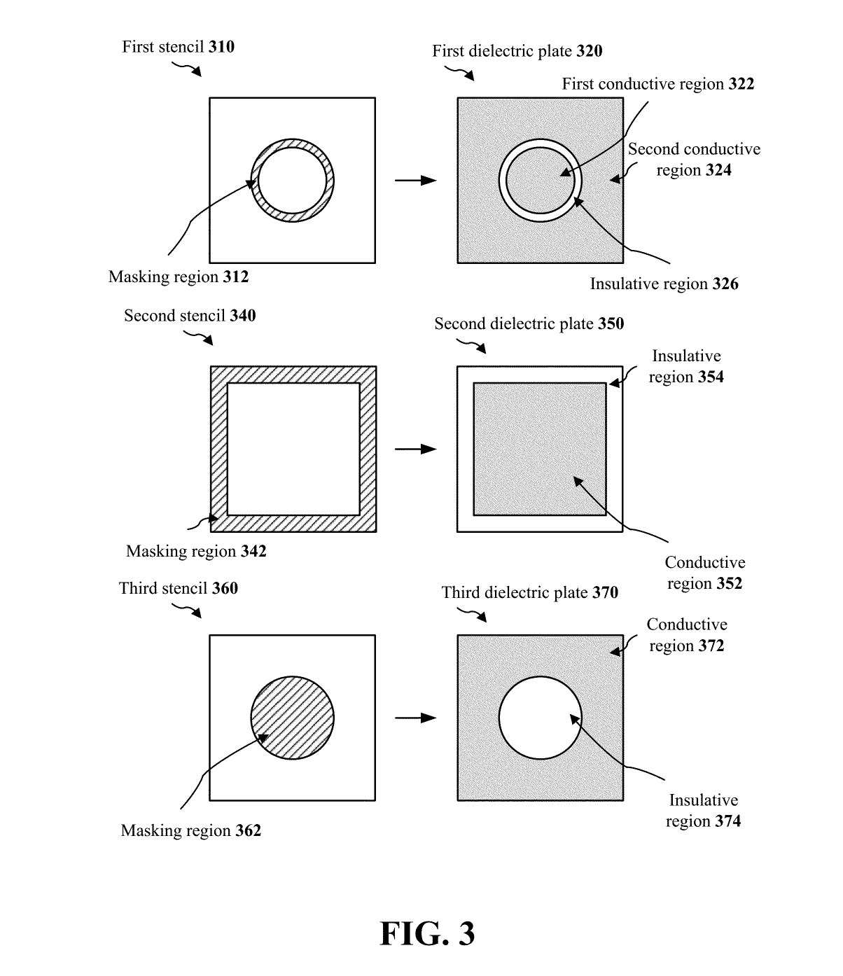

These steps may be formed in accordance with the features illustrated in FIGS. 3-6. FIG. 3 is a diagram illustrating a top view of the layers of the MLCC 100 in accordance with various aspects of the disclosure. As shown in FIG. 3, the MLCC 100 may include a first dielectric plate 320. The first dielectric plate 320 may be configured as the top and/or bottom plate of the MLCC 100. In an aspect, the first dielectric plate 320 may be a ceramic plate. In an aspect, a first conductive region 322 and a second conductive region 324 may be disposed on a surface of the first dielectric plate 320, where the first conductive region 322 and the second conductive region 324 are separated (e.g., electrically insulated) by an insulative region 326. In one example, the first conductive region 322 is disposed in an inner portion of the surface of the first dielectric plate 320, and the insulative region 326 surrounds the first conductive region 322.

In one example, the first dielectric plate 320 may be formed by applying a conductive material (e.g., conductive ink) onto the surface of a ceramic plate using a first stencil 310. The first stencil 310 includes a masking region 312 that blocks the application of the conductive material in a predetermined pattern, thereby forming the insulative region 326 and the conductive regions 322 and 324.

The MLCC 100 may further include at least one second dielectric plate 350 and at least one third dielectric plate 370. In one example, the at least one second dielectric plate 350 and at least one third dielectric plate 370 may be alternatively layered. For example, the interior layers (e.g., excluding the top layer and/or the bottom layer) of the MLCC 100 may include two or more of the second dielectric plates 350 and two or more of the third dielectric plates 370, such that the second dielectric plates 350 are interlaced with the third dielectric plates 370. In one example, the at least one second dielectric plate 350 and the at least one third dielectric plate 370 may be ceramic plates.

As shown in FIG. 3, a conductive region 352 may be disposed on a surface of the second dielectric plate 350. In an aspect, the conductive region 352 may be disposed on an inner portion of the surface of the second dielectric plate 350. As further shown in FIG. 3, the second dielectric plate 350 may include an insulative region 354, which may be at an outer portion (e.g., the edges) of the surface of the second dielectric plate 350. In one example, the second dielectric plate 350 may be formed by applying a conductive material (e.g., conductive ink) onto a surface of a ceramic plate using a second stencil 340. The second stencil 340 includes a masking region 342 that blocks the application of the conductive material in a predetermined pattern, thereby forming the insulative region 354.

As shown in FIG. 3, a conductive region 372 may be disposed on the third dielectric plate 370. In an aspect, the conductive region 372 may be disposed on an outer portion of the surface the third dielectric plate 370. As further shown in FIG. 3, the third dielectric plate 370 may include an insulative region 374, which may be at an inner portion of the surface of the third dielectric plate 370. In one example, the third dielectric plate 370 may be formed by applying a conductive material (e.g., conductive ink) onto a surface of a ceramic plate using a third stencil 360. The third stencil 360 includes a masking region 362 that blocks the application of the conductive material in a predetermined pattern, thereby forming the insulative region 374 and the conductive region 372.

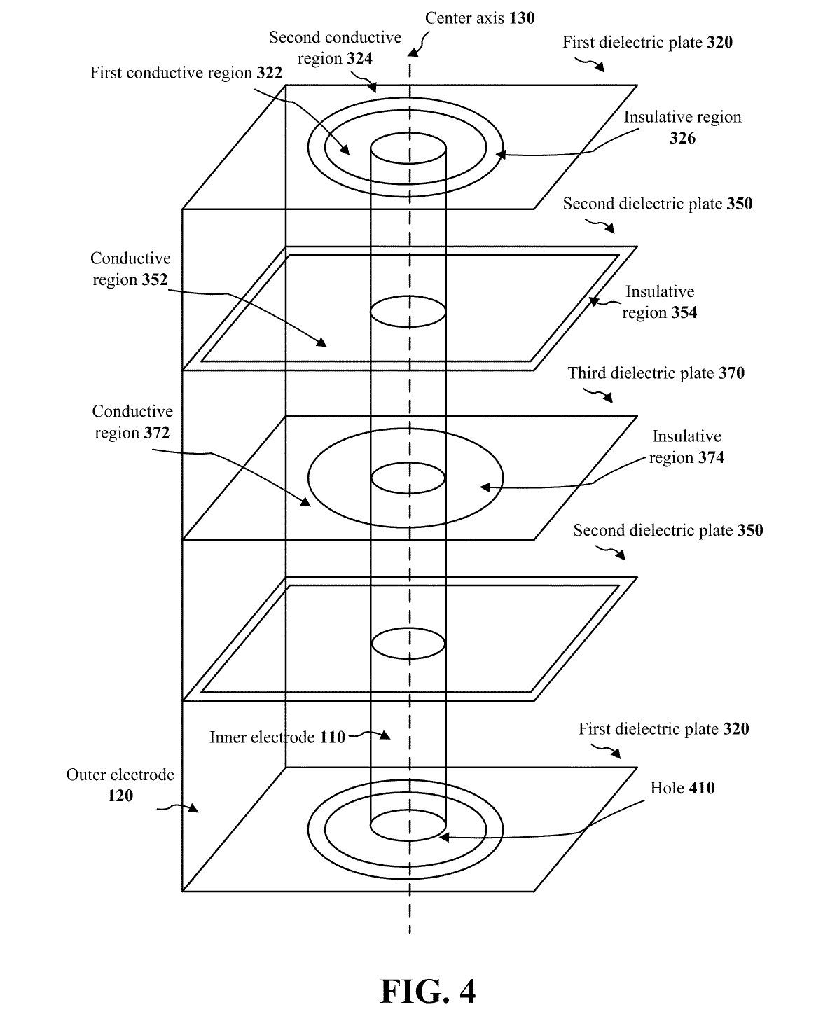

FIG. 4 is an illustration of the layering in the exemplary method for manufacturing the MLCC 100. Examples of layering include placing the dielectric plates on top of each other in a stack. The layered dielectric plates include the first dielectric plates 320 as the top plate and the bottom plate. The interior plates include the second dielectric plate 350 and the third dielectric plate 370 alternately layered. FIG. 4 further illustrates the center axis 130 extending through the layered dielectric plates. For example, the center axis 130 extends through the first conductive region 322 of the first dielectric plate 320, the conductive region 352 of the second dielectric plate 350, and the conductive region 372 of the third dielectric plate 370. A hole 410 is formed along the center axis 130, and the inner electrode 110 is formed in the hole 410. An outer electrode 120 is provided at an exterior surface of the layered dielectric plates.

Referring back to the flowchart 200 in FIG. 2, at step 230, an inner electrode is formed through an axis of the layered plurality of dielectric plates. The inner electrode electrically couples to the first conductive region on the surface of the first dielectric plate. At step 232, a hole is formed through the axis of the layered plurality of dielectric plates. At step 234, a conductive material is applied to coat an interior surface of the hole. Steps step 232 and step 234, illustrated in dotted-line, may be optional features.

These steps may be formed in accordance with the features illustrated in FIGS. 3-6. In an aspect, the hole 410 may be formed by laser drilling through the center axis 130. In an aspect, the inner electrode 110 may be formed by pulling up a conductive material (e.g., conductive ink) from the bottom to coat the interior surface of the hole 410. For example, the conductive material may be pulled up into the hole 410 by applying vacuum suction at the top of the hole 410. In an aspect, the hole 410 may not be filled by the conductive material, and the inner electrode 110 may be formed as a barrel. In such aspect, the inside of the hole 410 may be empty (only the surface of the hole 410 is coated with the conductive material). Thus, hole 410 is not filled by the conductive material for the inner electrode 234.

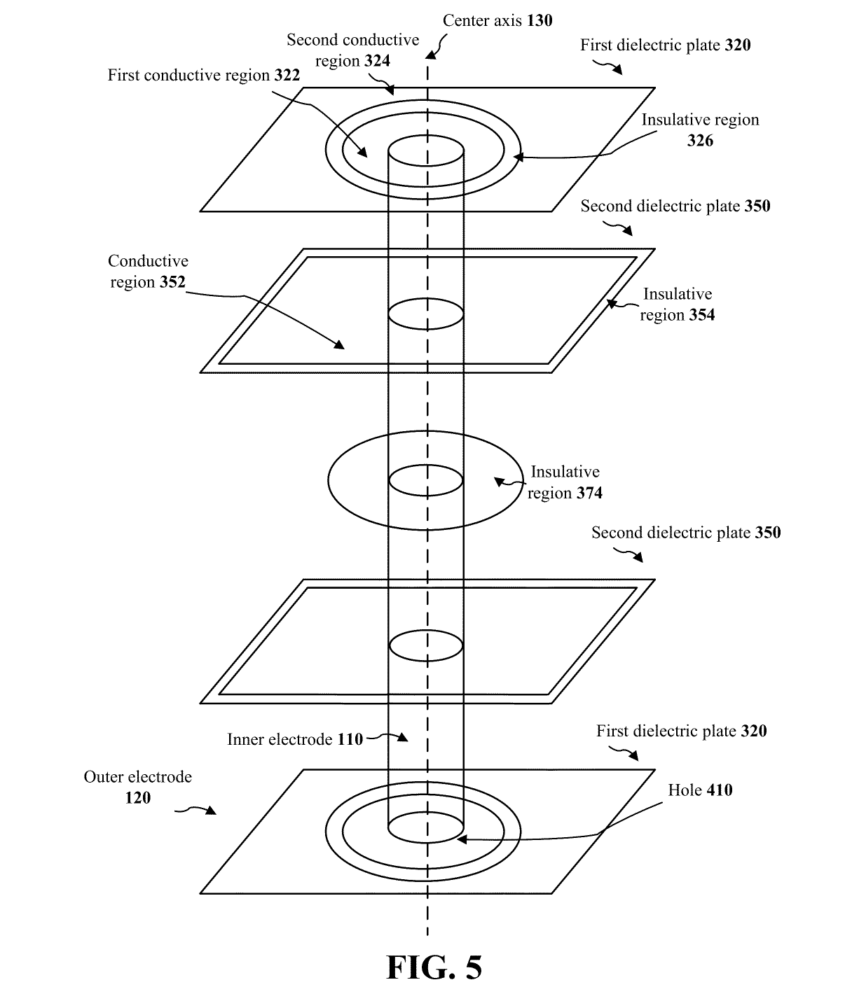

FIG. 5 is an illustration of the electrical connection of the inner electrode 110 to the layers of the MLCC 100. As shown in FIG. 5, the inner electrode 110 may be electrically coupled (e.g., electrically connected) to the first dielectric plate 320 at the first conductive region 322 and the second dielectric plate 350 at the conductive region 352. In an aspect, the inner electrode 110 may not be electrically coupled (e.g., electrically connected) to the third dielectric plate 370 because the insulative region 374 of the third dielectric plate 370 electrically insulates the inner electrode 110 from the conductive region 372 of the third dielectric plate 370.

Referring back to the flowchart 200 in FIG. 2, at step 240, an outer electrode is formed. The outer electrode electrically couples to the second conductive region on the surface of the first dielectric plate. At step 250, the outer electrode is formed by applying a conductive material for the outer electrode to an exterior surface of the layered number of dielectric plates and electrically coupling the outer electrode with a conductive region on a surface of the at least one third dielectric plate.

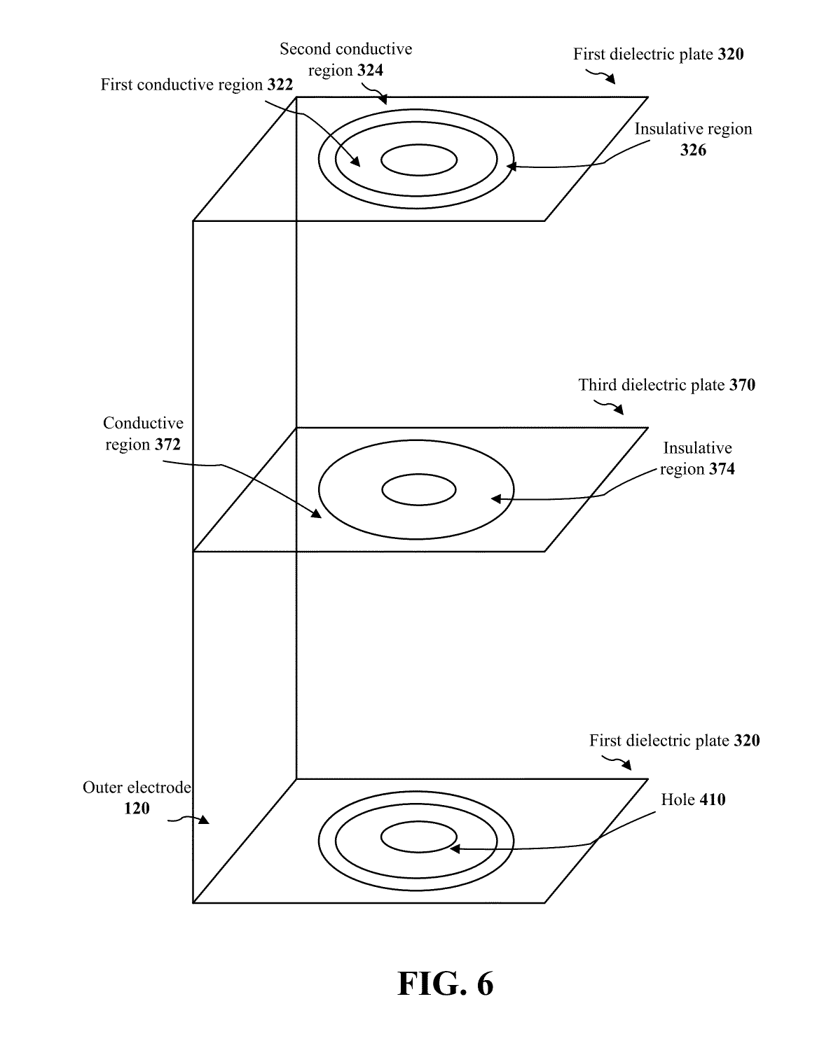

These steps may be formed in accordance with the features illustrated in FIGS. 3-6. FIG. 6 is an illustration of the electrical connection of the outer electrode 120 to the layers of the MLCC 100. As shown in FIG. 6, the outer electrode 120 is electrically coupled (e.g., electrically connected) to the first dielectric plate 320 at the second conductive region 324 and the third dielectric plate 370 at the conductive region 372. In an aspect, the outer electrode 120 may not be electrically coupled (e.g., electrically connected) to the second dielectric plate 350 because the insulative region 354 of the second dielectric plate 350 electrically insulates the outer electrode 120 from the conductive region 352 of the second dielectric plate 350.

Various advantages flow from the described exemplary embodiment. For example, the process of manufacturing the MLCC 100 is simplified according to the exemplary embodiment. The specific order or hierarchy of blocks in the method of operation described above is provided merely as an example. Based upon design preferences, the specific order or hierarchy of blocks in the method of operation may be re-arranged, amended, and/or modified. The accompanying method claims include various limitations related to a method of operation, but the recited limitations are not meant to be limited in any way by the specific order or hierarchy unless expressly stated in the claims.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

What is claimed is:

1. A method of manufacturing a capacitor, comprising:
layering a plurality of dielectric plates, wherein the plurality of dielectric plates includes a first dielectric plate having a first conductive region and a second conductive region on a surface of the first dielectric plate;
forming an inner electrode through an axis of the layered plurality of dielectric plates, wherein the inner electrode electrically couples to the first conductive region on the surface of the first dielectric plate;
forming an outer electrode, wherein the outer electrode electrically couples to the second conductive region on the surface of the first dielectric plate.

2. The method of claim 1, wherein the layered plurality of dielectric plates comprises at least one second dielectric plate and at least one third dielectric plate, further comprising alternately layering the at least one second dielectric plate and the at least one third dielectric plate.

3. The method of claim 2, wherein the first dielectric plate is a top or bottom of the layered plurality of dielectric plates.

4. The method of claim 3, wherein each of the plurality of dielectric plates includes a dielectric layer and a conductive layer disposed on a surface of the dielectric layer, forming at least one conductive region on the surface of the dielectric layer.

5. The method of claim 4, further comprising forming each of the plurality of dielectric plates by applying a conductive material for the conductive layer to the surface of the dielectric layer via a stencil, forming the at least one conducive region and at least one insulative region on the surface of the dielectric layer.

6. The method of claim 3, wherein the first dielectric plate includes an insulative region separating the first conductive region and the second conductive region on the surface of the first dielectric plate, and wherein the axis passes through the first conductive region of the first dielectric plate.

7. The method of claim 6, wherein the at least one second dielectric plate includes a conductive region at an inner portion of a surface of the at least one second dielectric plate, the inner electrode being electrically coupled to the conductive region on the surface of the at least one second dielectric plate.

8. The method of claim 7, wherein the at least one second dielectric plate includes an insulative region at an outer portion of the surface of the at least one second dielectric plate, the insulative region on the surface of the at least one second dielectric plate electrically insulates the outer electrode from the conductive region on the surface of the at least one second dielectric plate.

9. The method of claim 8, wherein the at least one third dielectric plate includes a conductive region at an outer portion of a surface of the at least one third dielectric plate, the outer electrode being electrically coupled to the conductive region on the surface of the at least one third dielectric plate.

10. The method of claim 9, wherein the at least one third dielectric plate includes an insulative region at an inner portion of the surface of the at least one third dielectric plate, and wherein the axis passes through the insulative region on the surface of the at least one third dielectric plate.

11. The method of claim 10, wherein the insulative region on the surface of the at least one third dielectric plate electrically insulates the inner electrode from the conductive region on the surface of the at least one third dielectric plate.

12. The method of claim 3, wherein forming the inner electrode comprises:
forming a hole through the axis of the layered plurality of dielectric plates; and
applying a conductive material to coat an interior surface of the hole, wherein the hole is not filled by the conductive material for the inner electrode.

13. The method of claim 12, wherein forming the inner electrode further comprises electrically coupling the inner electrode with a conductive region on a surface of the at least one second dielectric plate.

14. The method of claim 13, wherein the inner electrode is electrically insulated from the conductive region of the at least one third dielectric plate.

15. The method of claim 14, wherein forming the outer electrode comprises applying a conductive material for the outer electrode to an exterior surface of the layered plurality of dielectric plates and electrically coupling the outer electrode with the conductive region of the at least one third dielectric plate.

16. The method of claim 15, wherein the outer electrode is electrically insulated from the conductive region of the at least one second dielectric plate.
